(19) United States
(12) Patent Application Publication
(10) Pub. No.: US 2024/0326397 A1
(43) Pub. Date: Oct. 3, 2024

(54) LAMINATING DEVICE AND METHOD FOR INSTALLING FILM IN LAMINATING DEVICE

(71) Applicant: LAMI CORPORATION INC., Osaka (JP)

(72) Inventors: Jinichi NAGATA, Osaka (JP); Takashi ISHIBASHI, Osaka (JP); Yoshihisa SUGATA, Osaka (JP)

(73) Assignee: LAMI CORPORATION INC., Osaka (JP)

(21) Appl. No.: 18/281,168

(22) PCT Filed: Mar. 8, 2022
(86) PCT No.: PCT/JP2022/010147

§ 371 Date: Mar. 29, 2024

(30) Foreign Application Priority Data
Mar. 8, 2021 (JP) 2021-036783

(51) Int. Cl. B32B 37/00; B32B 38/00; B32B 41/00

(52) U.S. Cl. CPC B32B 37/0053; B32B 38/0004; B32B 41/00; B32B 2317/12

(57) ABSTRACT

A low-cost laminating device 1 having a structure in which two wound bodies 5a, 5b are installed above and below crimping rollers 8a, 8b, the wound body 5a is installed on the upper part of the crimping roller 8a, the wound body 5b is installed on the lower side of the conveying portion of the paper to be laminated, immediately in front of the crimping rollers 8a, 8b, and the device upper part 6 can be opened from the conveying path of the paper to be laminated to the upper part of the crimping rollers 8a, 8b so that the wound bodies 5a, 5b can be installed above and below, to avoid complicating the structure of the device, such as separating the internal unit of the device or pulling apart the paired rollers when installing or replacing a laminating film, in the laminating device.

### TECHNICAL FIELD

The present invention relates to a laminating device used for lamination processing performed for the purpose of improving durability and water resistance of various kinds of paper, and relates to an installing structure of a laminating film, identification of a film, measurement of a remaining amount, cutting of a film after lamination, and a method for installing a laminating film.

### BACKGROUND ART

For the purpose of improving the durability and water resistance of various kinds of paper such as business cards or other cards and restaurant menus, lamination processing is performed by sandwiching both sides of paper with a synthetic resin film of a sheet shape, and a laminating device capable of automatically performing this lamination processing has been conventionally used.

There are various structures of the laminating device, and most of them are configured such that a long synthetic resin film for lamination (hereinafter, simply referred to as a “film”) is wound around a film shaft to form a cylindrical shape, and then installed in the laminating device, and at the time of lamination work, the film is pulled out from the cylindrical wound body, and laminated on a lamination target object to be laminated such as a sheet in the device to perform lamination work.

The laminating device having such a structure has various features, and for example, there is a laminating device in which a guide roller of position-movable is provided, and a film is guided to a laminating roller that performs thermocompression bonding via the guide roller, so that the film is wound around the laminating roller more, and the film can be sufficiently heated (see, for example, Patent Literature 1).

In addition, as for the pulling of the film, there is a possibility that if the film is pulled out too much, the film may be wrinkled and stuck to the surface of the object to be laminated, or a defective product of lamination processing that causes positional displacement of the film may occur. Therefore, it has also been proposed to apply a constant braking force to the pulling of the film by applying a constant load to a shaft that holds a wound body of the film or a film holding unit that is in the middle of film supply to prevent the occurrence of the defective product (see, for example, Patent Literature 2).

Furthermore, in order to provide a laminating device that can sufficiently heat a film, have an easy structure, and easily install the film, the applicant proposes a configuration in which a sheet feeder unit that can be arbitrarily changed between an open state and a closed state, the film feeder has a roller at a position where the film is sufficiently wound around the heating roller, and the paper feeding unit has a counter roller that abuts on the roller in the closed state and is separated from the roller in the open state (see, for example, Patent Literature 3).

### CITATION LIST

### Patent Literature

Patent Literature 1: JP 2006-015516 A
Patent Literature 2: JP 2007-283728 A
Patent Literature 3: Japanese Translation of PCT International Application No. 2017/204344

### SUMMARY OF INVENTION

### Technical Problem

Meanwhile, a laminating device including the above patent literatures enables continuous work by using a film wound in a long roll shape. However, in a case where a laminating film is installed in the laminating device, a wound body needs to be placed in the device. However, the laminating film sandwiching upper and lower surfaces of a sheet of paper to be laminated is disposed above and below a conveying path of the sheet to be laminated in a manner of sandwiching the conveying path of the sheet to be laminated. Therefore, when the film is installed, the laminating film is hindered by other components, and it is difficult to manually install the film.

In addition, there is also a proposal to facilitate access to the inside by a structure in which other units in the inside can be attached and detached, and to reduce the burden on the operator at the time of film installation, but there is a disadvantage that the cost of the device increases.

Furthermore, there is also a structure in which two films are put together into one cassette and the laminating device cassette is installed by one-touch operation, and the film installation work is easy. However, there is a disadvantage that the cassette including the two films is large and heavy, is difficult to handle, and is costly, and the structure on the laminating device side is also complicated, and the cost is increased.

In addition, in order to make the lamination work possible, it is necessary not only to install the film in the device but also to pass the film through a predetermined position such as winding and setting the leading end portion of the film around a crimping roller in the main body of the laminating device, and it has been difficult to perform the lamination work unless the user is skilled in the work.

This work requires an operator of the laminating device to put both ends of the upper and lower films together and pass the film through the gap between the crimping rollers. However, since the film is thin and soft, workability is poor, and if the temperature of the roller at the time of film replacement is high, the operator may get a burn.

Furthermore, it is difficult to perform a work while aligning the upper and lower films, and there is a high possibility that loss occurs due to an installation error. For example, if the operator fails to accurately align the upper and lower films and pass the upper and lower films through the crimping roller, misalignment occurs at the leading end, and when the crimping proceeds sequentially, the misalignment of the upper and lower films increases.

On the other hand, in order to simplify the work of the operator, there is also a laminating device adopting a mechanism in which the upper and lower crimping rollers are separated and largely opened, and the upper and lower films can be easily passed through the largely opened gap of the crimping rollers. However, a mechanism for greatly moving at least one of the crimping rollers up and down with respect to the other is required, and there is a problem in that the structure is complicated and cost is increased.

In addition, there are many types of laminate films due to the thickness and other characteristics in addition to the film dimension (width), and there is a case where it is necessary to adjust heat and a feeding speed at the time of thermocompression bonding in accordance with the film characteristics. The operator needs to set the laminating device in accordance with the film characteristics. However, it takes time and effort to set the laminate film in accordance with the film characteristics, and if the setting is wrong due to an error of the operator, the lamination work may fail and loss may occur.

Furthermore, the laminating film wound as a wound body eventually will run out as the use is continued, but if the lamination work is continued after the film reaches the end, the axial center on the wound body side and the film end portion are connected and the film cannot be pulled out any more, an excessive force is applied to the film feeding mechanism, or if the film end is detached from the axial center, the sheet of paper to be laminated is thermocompression-bonded without the laminating film, and the lamination work fails.

Therefore, it is necessary to constantly recognize the remaining amount of the film wound around the wound body, to prevent the laminating device from continuously performing the lamination work when the end of the film is reached, and to prompt the operator or the user to replace the film wound body.

In order to constantly detect the remaining amount of the film, a detection method such as measuring the winding diameter of the film by mechanical contact or image processing, or measuring the film weight can be considered. However, in any case, the number of parts is large, the mechanism becomes complicated and expensive, and even in the case of mechanical contact, image processing, or weight measurement, in consideration of an accuracy error, replacement tends to be performed at a stage with a margin, and there is also a problem in that the film cannot be effectively used up to the end.

Therefore, if the information on the remaining amount of the film wound around the wound body can be always detected with high accuracy, the operator can grasp the time of film replacement and can use the film up to the end without waste, but there is no means for measuring the remaining amount with high accuracy at low cost.

In addition, after the film pulled out from the wound body is thermocompression-bonded to both sides of the sheet of paper to be laminated and subjected to lamination processing, it is necessary to cut the film continuous from the wound body on the trailing end side of the paper to be laminated. For this cutting operation, a method is generally used in which the film is sandwiched between a spiral blade of a rotary cutter provided with a spiral blade over a partial angle of the outer periphery of a cylindrical portion and a linear blade, and the rotary cutter is rotated and cut.

In the operation of the rotary cutter, since the cutting position accuracy is affected, the rotary cutter needs to be always accurately stopped at the origin, and a stepping clutch that always accurately stops at the origin by making one rotation by simple control is used for connection with a motor serving as a power source.

In the meantime, in the above cutting operation, in order to cleanly cut a film cured by thermal welding with a rotation of a rotary cutter using a drive source such as a motor by a stepping clutch, a force is required as compared with a film or a sheet feeding mechanism. In particular, when a thick film is cut, a rotational torque of the cutter increases, and thus a clutch having a specification with a large transmission torque is required as a clutch that can be used. A clutch having a large transmission torque is expensive, and a housing is large, so that a mounting space is also restricted.

As described above, a strong drive source such as a somewhat large motor is used for the cutter operation, but it is difficult to reduce the size and weight of the laminating device due to the location and weight of the strong drive source, and it is required to reduce the size and weight of the components of the cutting operation portion.

The present invention provides a structure of a laminating device and a method for installing a film in the laminating device that solves the above-described conventional problems at the time of film installation or at the time of lamination work in the laminating device.

### Solution to Problem

In order to solve the above problems, the invention of claim 1 employs, in a laminating device that performs lamination processing on a sheet of paper to be laminated conveyed into a device body while pulling out leading ends of laminating films in a state of a pair of wound bodies placed in the device body from the wound body, by thermocompression bonding and feeding the leading ends with a pair of crimping rollers in a state of sandwiching both surfaces of the sheet of paper to be laminated, a configuration in which the two wound bodies are installed above and below the crimping rollers in a manner of sandwiching the crimping rollers, the upper wound body is installed above the crimping rollers, the lower wound body is installed immediately in front of the crimping rollers on a lower side of a conveyance unit through which the sheet of paper to be laminated is conveyed to the crimping rollers, and the laminating device has a structure that can be opened from a conveying path for the sheet of paper to be laminated to an upper portion of the crimping rollers so that the upper and lower wound bodies is able to be installed.

The invention of claim 2 employs, in the laminating device according to the above-described claim 1, a configuration in which in a state where the lower wound body is held by a holding frame body, the holding frame body is detachably installed in the laminating device, and an upper surface of the holding frame body forms the conveying path for the sheet of paper to be laminated.

The invention of claim 3 employs, in a laminating device that performs lamination processing on a sheet of paper to be laminated conveyed into a device body while pulling out leading ends of laminating films in a state of a pair of wound bodies placed in the device body from the wound body, by thermocompression bonding and feeding the leading ends with a pair of crimping rollers in a state of sandwiching both surfaces of the sheet of paper to be laminated, a configuration in which, on the wound body side, an electronic component capable of holding and rewriting electronic information is installed, information on a characteristic of the film and information on a remaining amount of the film are recorded on the electronic component, the laminating device is set to perform lamination processing on the basis of the information received from the electronic component, and the information on the remaining amount of the film of the electronic component is rewritten to latest information on the remaining amount of the film based on the laminating processing performed by the laminating device.

The invention of claim 4 employs, in the laminating device according to the above-described claim 3, a configuration in which the electronic component is an RFID tag and a communication is performed with the laminating device using an NFC technology.

The invention of claim 5 employs, in a laminating device that performs lamination processing on a sheet of paper to be laminated conveyed into a device body while pulling out leading ends of laminating films in a state of a pair of wound bodies placed in the device body from the wound body, by thermocompression bonding and feeding the leading ends with a pair of crimping rollers in a state of sandwiching both surfaces of the sheet of paper to be laminated, and thereafter performs cutting trailing ends of the films of the laminated paper by rotation of a rolling cutter by a driving motor, a configuration in which a gear ratio between a gear of a cutter shaft of the rolling cutter and a gear on a side of stepping clutch that stops at an origin with one rotation at driving motor side is set to 2:1, so that the cutter makes one rotation in accordance with two rotations of the stepping clutch.

The invention of claim 6 employs, in the laminating device according to the above-described claim 5, a configuration in which in a case where the device is abnormally stopped in the middle of cutting, where the stepping clutch is turned one rotation at restarting, from a load current value of the driving motor to perform this operation, when it is determined that the cutter operation has been performed, the stepping clutch is rotated one more time to return to the origin, and when it is determined that the cutter operation has not been performed, the stepping clutch is stopped without any further operation.

The invention of claim 7 employs, in a method for installing a film in a laminating device, the laminating device performing lamination processing on a sheet of paper to be laminated conveyed into a device body while pulling out leading ends of laminating films in a state of a pair of wound bodies placed in the device body from the wound body, by thermocompression bonding and feeding the leading ends with a pair of crimping rollers in a state of sandwiching both surfaces of the sheet of paper to be laminated, a configuration in which the films pulled out from the wound bodies and a hard guide sheet are integrated, and the guide sheet is inserted between the crimping rollers, so that the pair of films are installed in the laminating device.

The invention of claim 8 employs, in the method for installing a film in a laminating device according to the above-described claim 7, a configuration in which both films of a pair of wound bodies are connected and integrated, and the guide sheet is pushed into the connection integrated film through the conveying path of the sheet of paper to be laminated in the laminating device and inserted between the crimping rollers, so that the pair of films are installed in the laminating device.

The invention of claim 9 employs, in the method for installing a film in a laminating device according to the above-described claim 7 or 8, a configuration in which a hole is made at a predetermined position of the guide sheet, and the position of the hole of the guide sheet is captured by a sensor on the laminating device side, which causes the laminating device to have recognition as installation work of the film, and to perform an operation suitable for installing the film.

### Advantageous Effects of Invention

As described above, according to the invention of claim 1, a structure is provided that can be opened from the conveying path of the sheet of paper to be laminated to the upper portion of the crimping roller so that the upper and lower wound bodies is able to be installed, the upper wound body is installed on the upper portion of the crimping roller, and the lower wound body is installed immediately in front of the crimping roller on the lower side of the conveyance unit through which the sheet of paper to be laminated is conveyed to the crimping roller. Therefore, only the film wound bodies needs to be attached and detached by being fitted in or removed from the upper side, so that the film installation and the film replacement work are simplified.

In addition, it is not necessary to disassemble and separate the internal unit of the laminating device or to separate the paired conveyance roller group and crimping roller group at the time of film installation or replacement, and the structure of the device is not complicated, and a low-cost laminating device can be provided.

Furthermore, with the structure that can be opened from the conveying path of the sheet of paper to be laminated to the upper portion of the crimping roller, there is also an advantage that processing becomes easy when the fed sheet of paper to be laminated is jammed.

According to the invention of claim 2, since the wound body to be installed in the lower side is installed in the laminating device after being installed in the holding frame in advance, the wound body can be easily attached as compared with the work of rotatably attaching the shaft of the wound body to a deep place on the lower side in the device.

In addition, since the wound bodies are separately installed and one held cassette (holding frame body) is installed instead of installing the cassette containing the two wound bodies, the holding frame body becomes a holding frame body that is small, easy to handle, and low cost, and the structure of the laminating device is also simplified and low cost as compared with the case of installing the cassette containing the two wound bodies.

Furthermore, the upper surface of the holding frame body can be used as a conveying path of the sheet of paper to be laminated, and can also serve as a guide path of the sheet of paper between the paper feeding unit and the crimping roller, which leads to simplification of the structure of the device and cost reduction.

According to the invention of claim 3, since the film type (width, thickness, surface property, remaining amount, and the like) information can be held as the electronic information in the electronic component on the film wound body side and displayed on the laminating device, the operator can work while confirming various settings according to the film characteristics on the basis of the information, the setting work of the operator is facilitated, and the setting (temperature setting, speed, and the like) on the laminating device side can be automatically performed on the basis of the film information held by the electronic component, and the work load of the operator can be reduced to prevent setting errors.

In addition, the remaining amount of the film of the film wound body can be held as electronic information, and the amount of the used film can be calculated from the drive information (rotation of the motor and rotation detection of the roller) of the laminating device and reflected in the remaining amount. Therefore, there is no mistake of continuing the lamination processing even though the film has run out, and there is no error such as conventionally performed mechanical contact or measurement of the remaining amount by the image processing sensor, and the film can be used up without waste.

According to the invention of claim 4, since the RFID technology and the NFC technology, which are established technologies, are applied to exchange of information between the electronic component on the film wound body side and the laminating device in claim 3, reliability of exchange of information can be obtained and cost can be reduced.

According to the invention of claim 5, since the acting force on the rolling cutter by the driving motor and the stepping clutch can be increased, a thicker film can be cut using the same driving motor and stepping clutch, and on the other hand, it is possible to reduce the driving motor and the stepping clutch in size and weight while maintaining the same cutting force, which leads to reduction in size and weight of the device and cost reduction.

According to the invention of claim 6, in the invention of claim 5, regarding the return when the cutting work is abnormally stopped, it is necessary to recognize the position of the rolling cutter and return the rolling cutter to the origin position. Even in such a case, it is possible to recognize the position of the rolling cutter and automatically return the rolling cutter to the origin position by monitoring the current value of the motor for driving the stepping clutch without using a sensor or the like.

According to the invention described in claim 7, the guide sheet is integrally provided at the leading end of the film, and the guide sheet is inserted between the crimping rollers, so that the film can be installed on the crimping rollers. Therefore, a soft film can be easily passed through the crimping rollers, which leads to improvement of workability of the operator, and reduction of time loss due to reduction of work errors of the operator.

In addition, the film is fed in a direction perpendicular to the shaft of the pressure bonding roller. If this direction is deviated, the film is deviated as the film is fed, and wrinkled or partially overlapped. However, since the film can be neatly inserted in the perpendicular direction between the crimping rollers by using the hard guide sheet at the leading end of the film, directionality of the film can be easily adjusted.

Furthermore, since the operator does not need to hold and pass a soft film between the crimping rollers having heat by hand and operates a relatively hard guide sheet, it is possible to prevent an accident such as burning due to touching the crimping rollers.

In addition, even in a laminating device without a mechanism for opening between the crimping rollers, it is possible to perform the film installation work easily without adding a dedicated machine, and eliminate the need for a mechanism for largely opening between the crimping rollers for film installation as in the conventional device, which reduces the cost of the entire device.

According to the invention described in claim 8, the film can be installed by a simple operation of sending the guide sheet to the conveying path of the sheet of paper to be laminated, and inserting the guide sheet can be performed without the laminating device being opened to expose the crimping rollers, and thus an accident in which the operator touches the crimping roller and burns does not occur.

Furthermore, by using an automatic paper feeding mechanism of the sheet of paper of the laminating device, when the automatic paper feeding mechanism is operated after the guide sheet is sandwiched between the crimping rollers, the film can be more easily installed.

According to the invention of claim 9, the laminating device side detecting a hole made in the guide sheet with a sensor causes the laminating device to have recognition as a film installation work, and the laminating device can change a special operation, for example, a conveyance speed of the sheet of paper only at the time of film installation, the cutting operation can be performed only for the trailing end side cutting because the first leading end side cutting operation is unnecessary, or the cutting position can be changed.

### BRIEF DESCRIPTION OF DRAWINGS

FIG. 1 is a transparent front view of a laminating device.

FIG. 2 is a transparent front view in a state in which a device upper part of the above device is opened.

FIG. 3 is a perspective view of a state in which films are connected to each other by a method for installing a film of the present invention.

FIGS. 4A and 4B are front views showing a method for installing a film of the present invention.

FIG. 5 is a perspective view of a state in which a guide sheet is connected to a film in another example of the method for installing a film of the present invention.

FIGS. 6A and 6B are front views showing another example of the method for installing a film of the present invention.

FIG. 7 is a perspective view of a state in which a guide sheet is connected to a film in still another example of the method for installing a film of the present invention.

FIGS. 8A and 8B are front views illustrating still another installation method of the present invention.

FIG. 9 is a perspective view illustrating components of a cutter unit of the present invention.

FIGS. 10A and 10B are explanatory views showing a relationship between a stepping clutch and a rolling cutter, where FIG. 10A is a view of a conventional laminating device, and FIG. 10B is a view of a laminating device of the present invention.

### DESCRIPTION OF EMBODIMENTS

Hereinafter, embodiments of the present invention will be described with reference to the accompanying drawings.

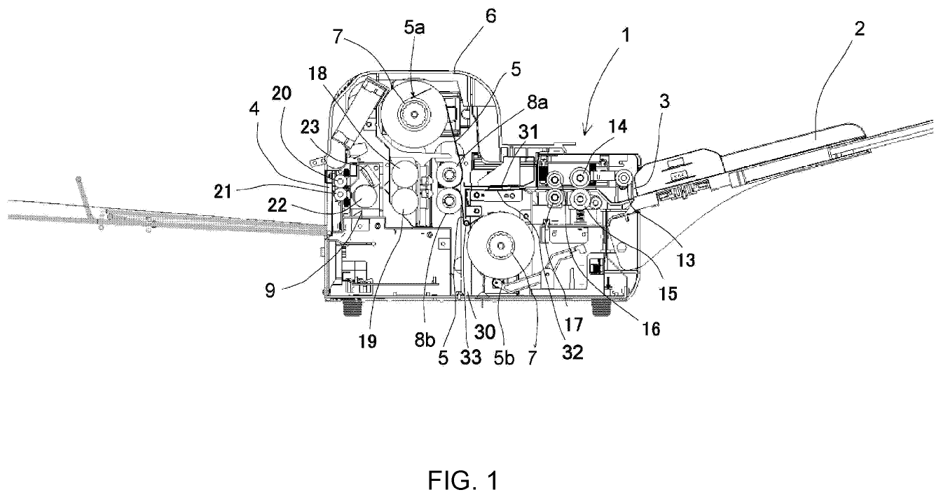

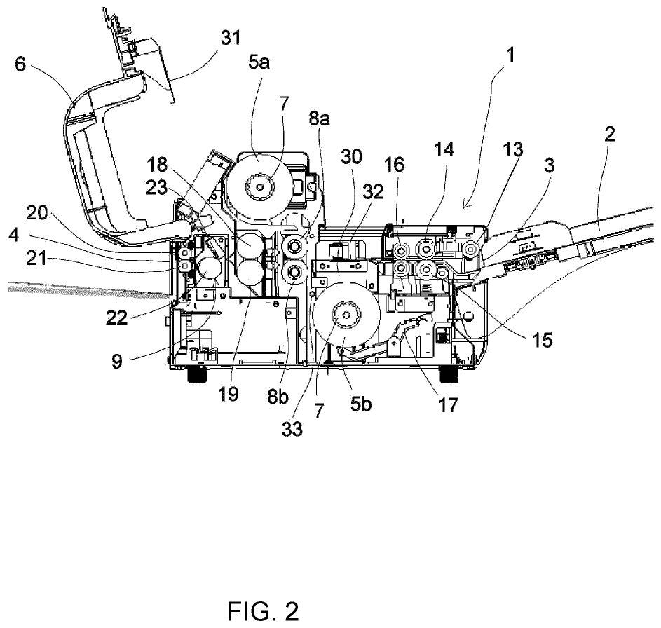

FIGS. 1 and 2 are transparent front views of a laminating device 1 used in the method for installing a film of the present invention.

First, the external appearance of the laminating device 1 includes a storage unit 2 that stores sheets of paper (not illustrated) to be laminated in an overlapping manner, an insertion groove 3 that is adjacent to the storage unit 2 and into which the sheets of paper are inserted one by one into the laminating device 1, and a discharge groove 4 that discharges the laminated sheet of paper to the outside of the laminating device 1.

In the laminating device 1, the inside of the laminating device 1 is opened by rotating a device upper part 6 about a hinge in order to install a laminating film 5 for lamination to the inside.

The inside of the laminating device 1 has a structure (not illustrated) in which two wound bodies 5a and 5b each obtained by winding the laminating film 5 for lamination on a core material 7 in advance in a roll shape are rotatably held at predetermined upper and lower positions of both ends of the core material 7.

Furthermore, a pair of upper and lower crimping rollers 8a and 8b is provided inside the laminating device 1, and to the crimping rollers 8a and 8b, the film 5 pulled out from the upper wound body 5a, the sheet to be laminated conveyed from the insertion groove 3, and the film 5 pulled out from the lower wound body 5b in a state of being laminated in this order from above, are inserted into a gap between the crimping rollers 8a and 8b, and by rotation and thermocompression bonding of the crimping rollers 8a and 8b, a sheet of paper to be laminated in which the films 5 and 5 are laminated on the upper and lower surfaces is obtained, and is discharged from the discharge groove 4, and the upper and lower films 5 and 5 are cut at a portion slightly exceeding the sheet of paper to be laminated by the cutter unit 9 provided immediately in front of the discharge groove 4.

When the work is performed on a plurality of sheets of paper, the sheet of paper to be laminated is continuously conveyed from the insertion groove 3 to the inside, and the same work is repeated.

In the case of a mechanism provided with the automatic sheet feeding mechanism, the insertion of the sheet of paper to be laminated and both films between the crimping rollers 8a and 8b and the cutting by the cutter unit 9 are automatically performed, and furthermore, the work on the plurality of sheets to be laminated is also automatically sequentially repeated.

The basic configuration and the basic operation of the laminating device 1 are as described above. Next, laminating processing steps of a sheet of paper to be laminated by this device will be described in detail. First, the sheet of paper to be laminated (not illustrated) stored in the storage unit 2 is drawn into the laminating device 1 using the motor-driven draw-in roller 13 provided above the insertion groove 3.

The sheet of paper drawn by the draw-in roller 13 is separated by a roller pair of an upper paper feed roller 14 and a lower separation roller 15 (rotated in a direction opposite to the upper paper feed roller 14), and even when a plurality of sheets of paper are sent, only one sheet of paper at the top of the sheets of paper is sent by the upper paper feed roller 14. That is, the sheet of paper other than the target one is pulled back to the storage unit 2 side by the lower separation roller 15.

The upper paper feed roller 14 and the lower separation roller 15 are pressed against each other at a predetermined pressure by a spring mechanism, a torque limiter is built in the lower separation roller 15, and the lower separation roller 15 overcomes the torque limiter and rotates in the forward direction in a state where only one sheet of paper is sandwiched.

The rotation of the upper paper feed roller 14 is started at the same timing as the rotation start of the draw-in roller 13, and the rotation is stopped after the sheet reaches conveyance rollers 16 and 17 in the rear side. The lower separation roller 15 also operates at the same timing as the draw-in roller 13.

The sheets of paper to be laminated sent one by one into the device body 2 with the above configuration are sent leftward in the drawing by the conveyance rollers 16 and 17, and sent to the crimping rollers 8a and 8b to be press-bonded with the film 5.

Note that, when two or more sheets of paper are continuously sent for lamination processing, the conveyance rollers 16 and 17 are rotated at a high speed when started to send the latter sheet of paper, and the distance between the leading end of the latter sheet of paper and the trailing end of the preceding sheet of paper is brought close to a predetermined distance. When the distance has approached the predetermined distance, the driving motors of the conveyance rollers 16 and 17 are switched to a low speed, and the sheet of paper is sent at the same speed as the preceding sheet of paper.

The mechanism is such that the sheet of paper to be laminated conveyed to the crimping rollers 8a and 8b is sandwiched, on the upper and lower surfaces, by the films 5 and 5 sent from the wound bodies 5a and 5b between the crimping rollers 8a and 8b, and the glue on the film surfaces is melted, so that the films are press-bonded with the sheet of paper.

The laminated sheet of paper that has been press-bonded by the crimping rollers 8a and 8b is sent to the pair of pull rollers 18 and 19 behind the sheet. The laminated sheet of paper sent to the pull rollers 18 and 19 is sent to the cutter unit 9, and the leading end portion of the laminated sheet of paper passes through the cutter unit 9, is sent out by the discharge rollers 20 and 21, and is discharged to the outside from the discharge groove 4. When the trailing end of the laminated sheet of paper falls on the cutter unit 9, the laminated portion of the films 5 and 5 slightly behind the trailing end of the laminated sheet of paper is cut.

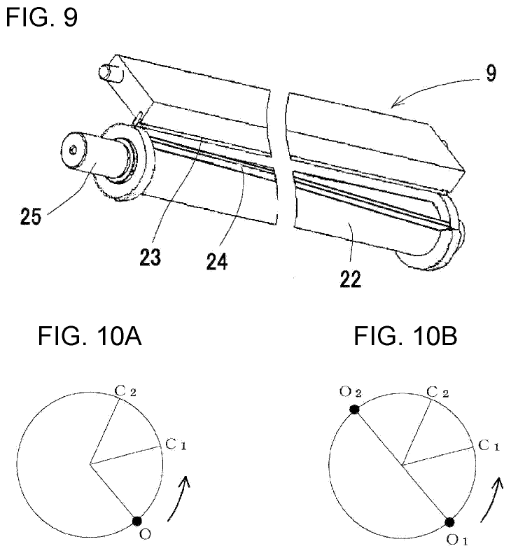

As illustrated in FIG. 9, the cutter unit 9 is constituted by a combination of a rotary cutter 22 and a linear blade 23. The rotary cutter 22 is provided with a spiral blade 24 over a partial angle of a cylindrical outer periphery. The spiral blade 24 and the linear blade 23 pass through a laminated portion of the films 5 and 5 between the spiral blade and the linear blade. The linear blade 23 is lowered so as to cut the portion to be cut at the middle between the trailing end of the preceding sheet of paper and the front end of the next sheet of paper. After the portion to be cut is sandwiched between the spiral blade 24, the rotary cutter 22 is rotated once to cut the laminated portion of the films 5 and 5. Note that, the laminated portion of the excess films 5 and 5 at the leading end portion of the most preceding workpiece and the trailing end portion of the last workpiece is also cut in the same manner as in the above method.

The laminated sheet of paper in which the trailing end portion is cut by the action is subsequently discharged from the discharge groove 4 to the outside of the laminating device 1 by the discharge rollers 20 and 21.

Next, a structure for installing the wound bodies 5a and 5b of the laminating film 5 in the laminating device 1 and a method for pulling out the laminating films 5 and 5 from the wound bodies 5a and 5b after installation to enable lamination processing, which are the contents of the present invention, will be described.

First, when the device upper part 6 of the laminating device 1 is opened, as illustrated in FIG. 2, the conveying path of the sheet of paper to be laminated from the pair of conveyance rollers 16 and 17 to the location between the pair of crimping rollers 8a and 8b is opened from the place where the wound body 5a above the pair of crimping roller 8a and 8b is to be installed.

In this state, the upper wound body 5a is fitted and fixed to a holding member that rotatably holds the core material 7 of the wound body 5a provided on the upper side of the crimping roller 8a, but a fixing structure and a fixing method of the holding member are not limited, and various currently known methods can be adopted. Since the wound body 5a can be fixed by work of simply fitting and fixing the wound body 5a from the upper side to the lower side, the work is easy.

The fixing structure of the wound body 5b on the lower side can also adopt the same structure as that of the wound body 5a, but in this embodiment, a structure is adopted in which the wound body 5b is held by the holding frame body 30 in advance, and then the holding frame body 30 is installed in the laminating device 1.

The holding frame body 30 is a frame body of a cassette shape having such a size that the new wound body 5b neatly enters, and is provided with a holding member having a known structure that rotatably holds the core material 7 of the wound body 5b inside, and is provided with an opening into which at least the new wound body 5b can be inserted, and an opening for pulling out the film 5 from the wound body 5b to the outside via the guide roller 33 incorporated in the holding frame body 30.

In addition, a known holding member capable of detachably holding the holding frame body 30 is provided below between the conveyance rollers 16 and 17 and the crimping rollers 8a and 8b of the laminating device 1, and the wound body 5b can be fixed at a predetermined position only by fitting and fixing the holding frame body 30 into this portion from above, so that the work is easy.

In addition, the holding frame body 30 after installation forms a part of a conveying path as a conveyance guide of the sheet of paper to be laminated between the conveyance rollers 16 and 17 and the crimping rollers 8a and 8b, the upper surface of the holding frame body 30 is formed as a lower conveyance guide 32, and when the device upper part 6 is closed together with the upper conveyance guide 31 provided inside the device upper part 6, the holding frame body forms a conveying path between the conveyance rollers 16 and 17 and the crimping rollers 8a and 8b by sandwiching the conveyed sheet of paper to be laminated between the upper conveyance guide 31 and the lower conveyance guide 32.

Next, the wound bodies 5a and 5b formed into films of a roll shape are installed by rotatably bearing respective shaft members 7 at a predetermined position in the device, and then the films 5 pulled out from both the wound bodies 5a and 5b are bonded to each other such that the vicinities of the leading end portions of the films 5 overlap each other and are continuous.

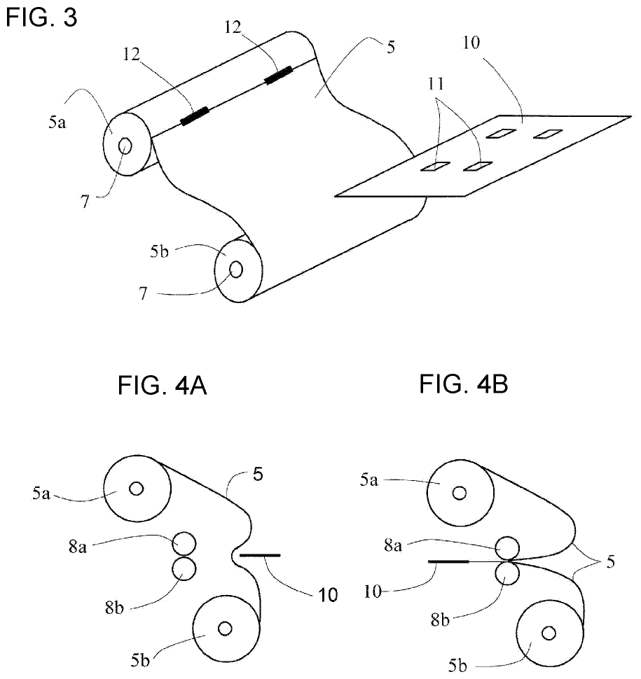

As illustrated in FIG. 3, the leading end portions of both the films 5 and 5 are bonded such that the leading end side of one film 5 (in the drawing, the film 5 pulled out from the lower wound body 5b) is bonded to the other film 5 (near the leading end side of the film 5 on the surface of the upper wound body 5a).

The bonding method is not particularly limited, but in this embodiment, the bonding is performed using the adhesive tape 12 or the like, and the film 5 is bonded and fixed along substantially the entire width of the side of the leading end of the film 5. At this time, it is necessary that the film 5 to be bonded is not inclined with respect to the other film 5, and both are firmly attached with the same directivity. Otherwise, the correction is not effective at the time of installation on the crimping rollers 8a and 8b, the films 5 and 5 are installed while the misalignment is generated, and there is a risk that the films may be laterally misaligned as the work proceeds.

Next, the device upper part 6 of the laminating device 1 is closed, with respect to the film 5 obtained by connecting and fixing the vicinities of the leading ends of both the films 5 and 5 so as to be continuous, a guide sheet 10 harder than the sheet of paper to be laminated is inserted from the insertion groove 3, and as illustrated in FIG. 3 and FIGS. 4(A) and 4(B), the film 5 is inserted and pushed between the crimping rollers 8a and 8b with the film 5 at the lead, and furthermore, the guide sheet 10 whose both surfaces are covered by both the films 5 and 5 is pulled out from the discharge groove 4, so that a pair of films can be installed.

The guide sheet 10 may be made of any of paper, synthetic resin, and cloth as long as it has substantially the same width as the width dimension of the sheet of paper to be laminated (generally, A4 size paper) by the film 5, is formed slightly shorter in the front-back direction than the sheet of paper to be laminated, has a quadrangular shape with a small thickness and is more rigid than the film 5 and is less likely to be easily bent or wrinkled.

At this time, the guide sheet 10 is inserted in a state where the crimping rollers 8a and 8b are freely rotated as necessary to rotate the guide sheet 10 in a direction in which the guide sheet advances, so that the guide sheet 10 can smoothly pass between the crimping rollers 8a and 8b.

After the guide sheet 10 and the films 5 and 5 sandwiching both surfaces of the guide sheet 10 pass through the crimping rollers 8a and 8b, the leading end portion of the guide sheet 10 covered with the films 5 and 5, which comes out of the discharge groove 4, is pulled out by hand, so that the guide sheet 10 and the films 5 and 5 pass between the crimping rollers 8a and 8b. When the film portion comes out of the discharge groove 4, the guide sheet 10 is separated together with the leading end portions of the films 5 and 5 by the action of the cutter unit 9, and the leading ends of the films 5 and 5 after cutting are aligned vertically near the cutter unit 9.

According to the method for installing the film 5 as described above, when the leading end portion of the flexible film 5 is passed between the crimping rollers 8a and 8b, since the film 5 is thin and soft, workability is poor, and it is difficult to accurately install the film 5 unless the film 5 is wrinkled or when the operator is not familiar with the work. However, the insertion work between the crimping rollers 8a and 8b is facilitated by passing the film 5 together with the relatively rigid guide sheet 10.

In addition, when the film replacement is required in the middle of the continuous work, if the work is performed while the temperature of the crimping rollers 8a and 8b is still high, there is a possibility that the operator may get burned. However, it is only required to push the guide sheet 10 from the insertion groove 3 into between the insertion crimping rollers 8a and 8b while the device upper part 6 is closed, and further pull the passing guide sheet 10, and no hand touches the crimping rollers 8a and 8b, and there is no risk of burning.

Note that if the guide sheet 10 is fed using the automatic paper feeding mechanism of the sheet of paper included in the laminating device 1, the film 5 can be more easily installed. The laminating device 1 can be provided with only a laminate start button without providing a dedicated film installation button or the like for performing an operation at the time of the film device.

At this time, in order to cause the laminating device 1 to have recognition as a film installation work using the guide sheet 10 in order to reduce operational errors and reduce costs, as illustrated in FIG. 3, holes 11 are made in the guide sheet 10 in accordance with the position of a sheet detection photosensor (not illustrated) provided on the laminating device 1 side.

That is, when the laminating device 1 side detects the holes 11 formed in the guide sheet 10, it is possible to cause the laminating device 1 to have recognition as a film installation work and to perform a special operation. For example, it is possible to change the conveyance speed of the sheet of paper only at the time of installing the film, or to change the cutting position only by cutting the trailing end since the first cutting work on the leading end side is unnecessary.

At the time of the normal lamination operation, even if work is performed on a special sheet of paper to be laminated having a hole, unless the hole has the same distance and the same size from the leading end as those of the guide sheet 10 serving as a guide, control can be performed so that malfunction does not occur.

Next, a method for installing a film different from the above will be described.

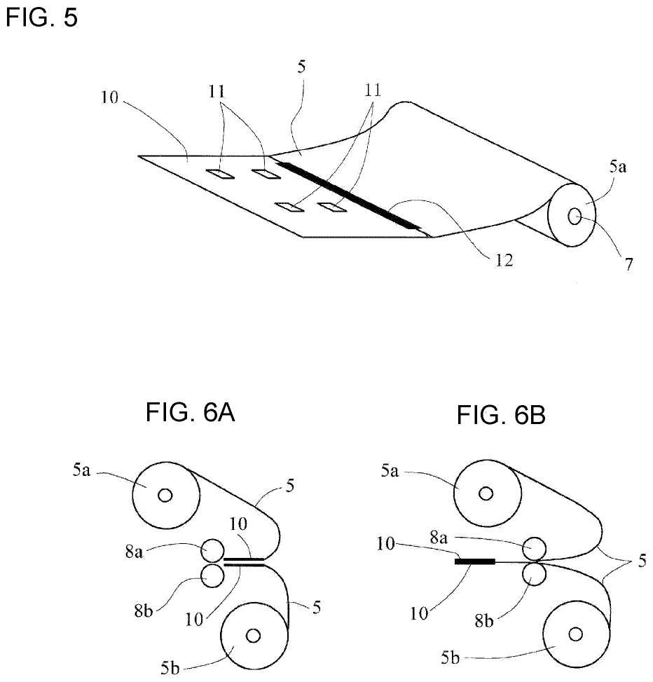

As illustrated in FIG. 5, first, the guide sheet 10 is connected and fixed to the leading ends of the films 5 and 5 taken out from both the wound bodies 5a and 5b installed in the laminating device 1. A method of connecting and fixing the films 5 and 5 to the guide sheet 10 is not particularly limited, but the connection between the films 5 and 5 by the adhesive tape 12 is convenient with good workability.

Next, as illustrated in FIGS. 6(A) and 6(B), the films 5 pulled out from the upper and lower wound bodies 5a and 5b to which the guide sheet 10 is attached at the leading ends are simultaneously inserted between the crimping rollers 8a and 8b, and thermocompression bonding is performed.

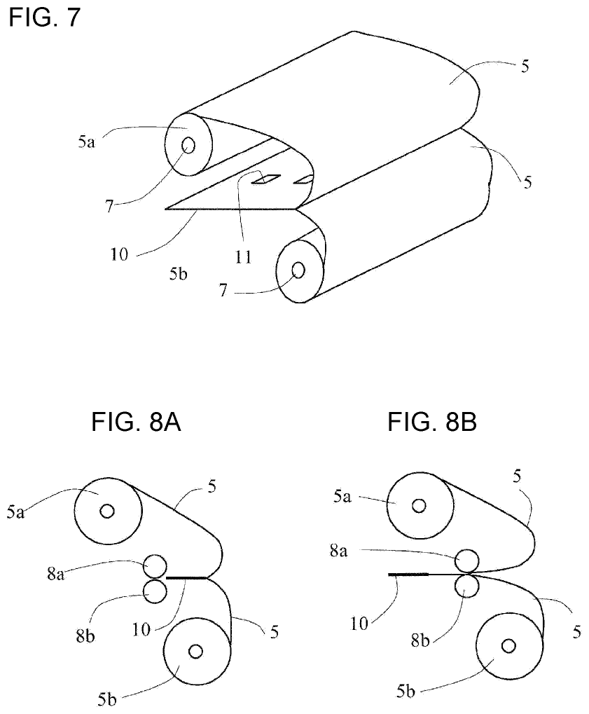

As another method, as illustrated in FIG. 7, the leading ends of the pair of upper and lower films 5 and 5 are attached to the one guide sheet 10. The method of connecting and fixing the guide sheet 10 to the films 5 and 5 is the same as the method of FIGS. 5 and 6, and for example, connection and fixing are performed using an adhesive tape 12.

Thereafter, as illustrated in FIGS. 8(A) and 8(B), if one guide sheet 10 to which both the films 5 and 5 are attached is set as a lead, and the guide sheet is inserted between the crimping rollers 8a and 8b and thermocompression-bonded, both the films 5 and 5 can be installed.

Note that, in the case of the installation methods illustrated in FIGS. 5 to 8, when both the films 5 and 5 are attached to the guide sheet 1, it is necessary to attach both the films 5 and 5 such that both the films 5 and 5 overlap each other with their directionalities firmly aligned. If the upper and lower films 5 and 5 are misaligned when attached to the guide sheet 10, correction is not effective at the time of installation to on the crimping rollers 8a and 8b, and the films 5 and 5 are installed while the misalignment is generated, and there is a risk that both the films 5 and 5 are laterally misaligned as the work proceeds.

In addition, since the guide sheet 10 and the film 5 are integrated, it is not possible to adopt a simple method of inserting the guide sheet 10 from the insertion groove 3 as in the embodiment illustrated in FIGS. 3 and 4, and it is necessary to perform the operation while keeping the device upper part 6 open. However, since the hard guide sheet 10 is inserted between the crimping rollers 8a and 8b as the lead, there is no concern that the film will be wrinkled at the time of installation or the operator will get burned.

Next, a mechanism for causing the laminating device to recognize the characteristics and the remaining amount of the laminating film will be described. First, there are many types of laminating films 5 due to the thickness and other characteristics in addition to the film dimension (width), and there is a case where it is necessary to adjust heat and a feeding speed at the time of thermocompression bonding in accordance with the film characteristics. The operator needs to set the laminating device in accordance with the film characteristics. However, it takes time and effort to set the laminate film in accordance with the film characteristics, and if the setting is wrong due to an error of the operator, the lamination work may fail.

In addition, the film 5 wound as the film wound bodies 5a and 5b eventually will run out as the use is continued, but if the lamination work is continued after the film 5 reaches the end, the lamination operation fails. Therefore, it is necessary to constantly recognize the remaining amount of the film 5 wound around the wound bodies 5a and 5b, and to prevent the laminating device 1 from continuously performing the lamination work when the film 5 reaches the end of the film 5, and to display a message prompting an operator or a user to replace the film wound bodies 5a and 5b.

In order to constantly detect the remaining amount of the film, there is a detection method such as measuring the winding diameter of the film by mechanical contact or image processing, or measuring the film weight. However, the number of parts is large, the mechanism is complicated, and the cost is high. In addition, even when mechanical contact, image processing, or weight measurement is performed, the film wound bodies 5a and 5b tend to be replaced at a stage where there is a margin for safety in consideration of an accuracy error, and the film 5 cannot be effectively used up to the end.

Therefore, in the embodiment of the present invention, an IC chip or an RFID tag is provided on the film wound body side, and an NFC module or the like capable of reading and writing information on the IC chip or the RFID tag is provided at a position communicable with the IC chip or the RFID tag on the film wound body side when the film wound body is installed in the laminating device, so that the characteristic information and the remaining amount information of the film recorded on the IC chip or the RFID tag can be detected with high accuracy in a wireless manner on the laminating device side.

Note that rad frequency identification (RFID) is an automatic recognition technique for reading and writing tag data using wireless communication, and an IC tag created using this technique is referred to as an RFID tag. In addition, near field communication (NFC) is called a near field communication standard, and is generally used in an IC card or the like for payment of electronic money or payment of a traffic fare by a reader/writer function by simply holding an RFID tag or the like over a device. In this embodiment, a description will be given below on the assumption that the RFID tag is used.

When the replacement film wound bodies 5a and 5b are produced in advance, the type (width, thickness, surface property, remaining amount, and the like) of the film 5 is registered in RFID chips on the film wound bodies 5a and 5b side using an appropriate writing electronic device. Some of the RFID chips are very small and use a wireless technology, and thus, for example, the RFID chips can be provided at appropriate places in the core material 7 of the wound bodies 5a and 5b.

Then, when the film wound bodies 5a and 5 are set in the laminating device 1, information on the film 5 side is read using an RFID reader/writer function of an NFC module provided at a position communicable with the RFID chip provided on the core material 7 of the film wound bodies 5a and 5b provided on the laminating device 1 side, the information on the film 5 side is displayed on a display portion such as an operation panel, and the operator can easily confirm the information.

In addition, by automatically performing setting (temperature setting, speed, and the like) on the machine side on the basis of the film type (width, thickness, surface property, remaining amount, and the like) information, it is possible to reduce the work load of the operator and prevent an error.

Although the remaining amount of the film 5 changes (decreases) every time the lamination work is performed, it is possible to calculate the amount (dimension) of the film 5 used from the driving information (rotation of the motor and rotation detection of the roller) of the laminating device 1 from the film remaining amount information of the RFID tag on the film wound bodies 5a and 5b side and reflect the calculated amount in the remaining amount. As a method of displaying the remaining amount on a display portion such as an operation panel, it is also possible to display the remaining amount (dimension) of the film and the number of remaining sheets of paper to be laminated that can be processed (for example, the number of sheets in A4 paper conversion).

At the same time as the display of the remaining amount in the laminating device 1, the film remaining amount information at the present time is sent from the laminating device 1 to the RFID tag side of the film wound bodies 5a and 5b, and the remaining amount information is rewritten. In this way, the RFID tags on the film wound bodies 5a and 5b sides in the middle of use always hold the latest remaining amount information, and when the film wound bodies 5a and 5b are replaced with another film wound body without being used up (for example, once the need arises to use a film with different lamination characteristics, etc.), even if the film wound bodies 5a and 5b are replaced again with the original film wound bodies 5a and 5b in the middle of use, accurate remaining amounts can be displayed by the latest remaining amount information held by the film wound bodies 5a and 5b.

When the remaining amount of the film becomes equal to or less than a specified value (for example, a dimension capable of laminating a sheet of paper to be laminated) on the basis of the information of the remaining amount of the film, the laminating device 1 immediately displays a prompt of film replacement so as to alert the user, so that the film can be used up without waste.

Next, the structure of the cutter unit 9 in the laminating device of the present invention will be described.

The structure of the cutter unit 9 is as illustrated in FIG. 9 described above, and includes a rotary cutter 22 having a spiral blade 24 and a linear blade 23.

The rotary driving force of the rotary cutter 22 is received from a driving motor (not illustrated), and is provided through a stepping clutch (not illustrated). As a reason for adopting the stepping clutch, since it affects the cutting position accuracy, the cutter needs to be always accurately stopped at the origin, and the stepping clutch that is always accurately stopped at the origin by rotating once with simple control is used.

In addition, even in a case where the machine is abnormally stopped in the middle of cutting (such as instantaneous power interruption or film jamming), there is an advantage that it is not necessary to perform an origin return operation at restarting since the machine is mechanically returned to the origin without fail when being restarted due to the mechanism of the stepping clutch.

In the structure of the conventional laminating device, the gear ratio between the gear of the cutter shaft 25 and the stepping clutch is 1:1, and the rotary cutter 22 is controlled so as to make one rotation in accordance with one rotation of the clutch. As a locus on the circumference of the rotary cutter 22 illustrated in FIG. 10(A), the cutting work is performed at a portion where the linear blade and the spiral blade 24 overlap each other (cutting start position C₁ to cutting end position C₂) while the linear blade 23 makes one rotation in the arrow direction from the origin position O and returns to the origin position O. In this case, the rotation of the stepping clutch and the rotation of the rotary cutter 22 coincide with each other.

In contrast in the embodiment of the laminating device of the present invention, the gear ratio between the gear of the cutter shaft 25 of the rotary cutter 22 and the clutch side is set to 2:1, and the rotary cutter 22 makes one rotation in accordance with two rotations of the clutch. That is, as illustrated in FIG. 10(B), when the stepping clutch makes one rotation, the rotary cutter 22 rotates ½ in the arrow direction from the origin position O₁ and moves only to the position O₂, and the rotary cutter 22 returns to the origin position O₁ when the stepping clutch makes another one rotation.

This is because the necessary transmission torque on the clutch side is ½ of the necessary rotation torque of the rotary cutter 22, and thus a smaller and inexpensive motor or stepping clutch can be used.

However, for this reason, in a conventional case where the rotary cutter 22 makes one rotation in accordance with one rotation of the stepping clutch, in a case where the rotary cutter is abnormally stopped in the middle of cutting, the rotary cutter is automatically returned to the origin position by the operation of the stepping clutch. However, in a case where the cutter unit 9 having the structure of the embodiment of the present invention is provided, the operation for return differs depending on the stop timing.

That is, in a case where the clutch stops in the middle of the first rotation, the clutch needs to be further rotated one more time at the time of re-driving, and in a case where the clutch stops in the middle of the second rotation, the clutch returns to the origin mechanically at the time of re-driving, so that no counterstatement is required.

For these determinations, it is necessary to add a mechanism for confirming whether the position of the rotary cutter 22 has returned to the origin position O₁. However, adding a sensor or the like for this purpose increases the cost, and thus, in this embodiment, the addition is avoided by the following method.

As illustrated in FIG. 10(B), in the first rotation of the stepping clutch, the rotary cutter 22 cuts the film between the cut start position C₁ and the cut end position C₂ and stops at the position O₂, and in the second rotation, the rotary cutter idles to the origin position O₁. Therefore, the film cutting operation is performed at restarting after the abnormal stop, and the load (current value) of the motor is monitored to determine whether the film cutting operation has been performed in the clutch ON in the first rotation, and the film cutting operation is determined.

At the time of film cutting, the load of the motor increases due to the contact between the linear blade 23 and the spiral blade 24 of the rotary cutter 22 (C₁ to C₂ in FIG. 10(B)). Therefore, if the current value in a case where the current value corresponds to the film cutting operation is detected, the stepping clutch can be determined to be the first rotation because the rotary cutter 22 is at the position O₁, the rotary cutter 22 is determined to be the position O₂ of the half rotation, and the stepping clutch is rotated one more time to return the rotary cutter 22 to the origin position O₁.

On the other hand, when the stepping clutch is at the O₂ position, the current value does not indicate a value corresponding to the film cutting operation unless the stepping clutch is cut by the first clutch ON. Therefore, it can be determined that the stepping clutch is stopped in the middle of the first rotation, and it can be determined that the stepping clutch returns to the origin position O₁ as it is at the first rotation.

The embodiments of the laminating device and the method for installing a film in the laminating device of the present invention described above are merely examples, and can be implemented by appropriately changing the design within the scope of the object of the present invention.

### REFERENCE SIGNS LIST

1 laminating device
2 storage unit
3 insertion groove
4 discharge groove
5 film
5a, 5b wound body
6 device upper part
7 core material
8a, 8b crimping roller
9 cutter unit
10 guide sheet
11 hole
12 adhesive tape
13 draw-in roller
14 upper paper feed roller
15 lower separation roller
16 conveyance roller
17 conveyance roller
18 pull roller
19 pull roller
20 discharge roller
21 discharge roller
22 rolling cutter
23 linear blade
24 spiral blade
25 cutter shaft
30 holding frame body
31 upper conveyance guide
32 lower conveyance guide
33 guide roller

1. A laminating device configured to perform lamination processing on a sheet of paper to be laminated conveyed into a device body while pulling out leading ends of laminating films in a state of a pair of wound bodies placed in the device body from the wound body, by thermocompression bonding and feeding the leading ends with a pair of crimping rollers in a state of sandwiching both surfaces of the sheet of paper to be laminated, wherein
the two wound bodies are installed above and below a conveying path of the sheet to be laminated in a manner of sandwiching the conveying path of the sheet to be laminated, the upper wound body is installed above the crimping rollers, the lower wound body is installed immediately in front of the crimping rollers on a lower side of a conveyance unit through which the sheet of paper to be laminated is conveyed to the crimping rollers, and the laminating device has a structure that can be opened from a conveying path for the sheet of paper to be laminated to an upper portion of the crimping rollers so that the upper and lower wound bodies is able to be installed.

2. The laminating device according to claim 1, wherein in a state where the lower wound body is held by a holding frame body, the holding frame body is detachably installed in the laminating device, and an upper surface of the holding frame body forms the conveying path for the sheet of paper to be laminated.

3. A laminating device configured to perform lamination processing on a sheet of paper to be laminated conveyed into a device body while pulling out a pair of leading ends of laminating films in a state of a pair of wound bodies placed in the device body from the wound body, by thermocompression bonding and feeding the leading ends with a pair of crimping rollers in a state of sandwiching both surfaces of the sheet of paper to be laminated, wherein
on the wound body side, an electronic component capable of holding and rewriting electronic information is installed, information on a characteristic of the film and information on a remaining amount of the film are recorded on the electronic component, the laminating device is set to perform lamination processing on a basis of the information received from the electronic component, and the information on the remaining amount of the film of the electronic component is rewritten to latest information on the remaining amount of the film based on the laminating processing performed by the laminating device.

4. The laminating device according to claim 3, wherein the electronic component is an RFID tag and a communication is performed with the laminating device using an NFC technology.

5. A laminating device configured to perform lamination processing on a sheet of paper to be laminated conveyed into a device body while pulling out leading ends of laminating films in a state of a pair of wound bodies placed in the device body from the wound body, by thermocompression bonding and feeding the leading ends with a pair of crimping rollers in a state of sandwiching both surfaces of the sheet of paper to be laminated, and thereafter perform cutting trailing ends of the films of the laminated paper by rotation of a rolling cutter by a driving motor, wherein
a gear ratio between a gear of a cutter shaft of the rolling cutter and a gear on a side of stepping clutch that stops at an origin with one rotation at driving motor side is set to 2:1, so that the cutter makes one rotation in accordance with two rotations of the stepping clutch.

6. The laminating device according to claim 5, wherein in a case where the device is abnormally stopped in the middle of cutting the films, where the stepping clutch is turned one rotation at restarting, from a load current value of the driving motor to perform this operation, when it is determined that the cutter operation has been performed, the stepping clutch is rotated one more time to return to the origin, and when it is determined that the cutter operation has not been performed, the stepping clutch is stopped without any further operation.

7. A method for installing a film in a laminating device, the laminating device performing lamination processing on a sheet of paper to be laminated conveyed into a device body while pulling out leading ends of laminating films in a state of a pair of wound bodies placed in the device body from the wound body, by thermocompression bonding and feeding the leading ends with a pair of crimping rollers in a state of sandwiching both surfaces of the sheet of paper to be laminated, wherein
the films pulled out from the wound bodies and a hard guide sheet are integrated, and the guide sheet is inserted between the crimping rollers, so that the pair of films are installed in the laminating device.

8. The method for installing a film in a laminating device according to claim 7, wherein both films of a pair of wound bodies are connected and integrated, and the guide sheet is pushed into the connection integrated film through the conveying path of the sheet of paper to be laminated in the laminating device and inserted between the crimping rollers, so that the pair of films are installed in the laminating device.

9. The method for installing a film in a laminating device according to claim 7 or 8, wherein when a hole is made at a predetermined position of the guide sheet, and the position of the hole of the guide sheet is captured by a sensor on the laminating device side, which causes the laminating device to have recognition as installation work of the film, and to perform an operation suitable for installing the film.
